(19) United States
(12) Patent Application Publication
(10) Pub. No.: US 2013/0006678 A1
(43) Pub. Date: Jan. 3, 2013

(54) SYSTEM AND METHOD FOR DETECTING HUMAN-SPECIFIED ACTIVITIES

(75) Inventors: Victoria M. Bellotti, San Francisco, CA (US); Oliver Brdiczka, Mountain View, CA (US); Laurian Claire Vega, Christiansburg, VA (US)

(73) Assignee: PALO ALTO RESEARCH CENTER INCORPORATED, Palo Alto, CA (US)

(21) Appl. No.: 13/171,087

(22) Filed: Jun. 28, 2011

(51) Int. Cl. G06Q 10/00

(52) U.S. Cl. 705/7.11

(57) ABSTRACT

Embodiments of the present invention provide a system for identifying user activities. The system collects activity descriptions from a plurality of users, wherein a respective user is allowed to add, remove, or vote for at least one feature associated with the activity from a predetermined viewpoint. The system then identifies a user activity as a typed, stateful, and instantiated entity by detecting one or more features associated with at least one of: a type, state, and instance, of the entity.

### BACKGROUND

1. Field

This disclosure is generally related to activity management. More specifically, this disclosure is related to detecting human-specified activities.

2. Related Art

Modern-day workers often find themselves juggling multiple tasks and activities. Many task-management systems have been developed to assist these multitasking efforts, particularly for computer-based work. Task-management systems typically provide some efficient way of switching from one task to another. In order to facilitate task management and task switching, a task-management system needs to have knowledge of how a user's overall workspace is conceptually partitioned into the individual constituent tasks. Note that performing a task often involves the use of multiple applications, documents, and mechanisms for communicating with others.

One common problem facing the task-management system is to determine which documents or applications are associated with each task. For example, in order to assist a user with task switching, the system needs to recognize that task switching has occurred when the user opens a document belonging to a different task.

Conventional task-detection methods either require high amounts of user feedback, or provide a rather imprecise representation of a user's task. For example, some task-management systems rely on explicit user input for such knowledge, thus generating an extra burden for users. Some task-detection methods automatically learn a user's tasks in a supervised manner by collecting ongoing data for user actions, which requires a user to provide task names/labels for the data constantly in order to train the system. Due to the large amount of “extra work” involved in setting up such systems, normal users tend to reject such approaches. In contrast, unsupervised approaches do not require any feedback from users, but generally provide a poor task-detection result.

Conventional task-detection methods for computer-based work also fail to differentiate between human-specified types of activity such as “writing a patent” versus “hiring a new employee” and to recognize that two different activities may be different instances of the same type. They also fail to recognize the state of an activity instance such as documenting the invention idea versus working on a rebuttal during prosecution of the patent application.

### SUMMARY

One embodiment of the present invention provides a system for identifying user activities. The system collects activity type descriptions from a plurality of users, wherein a respective user is allowed to add, remove, or vote for at least one feature associated with the activity type from a predetermined viewpoint.

The system also collects data from human activity such as key-presses or sensor-detected movements and identifies a user activity as a typed entity by detecting one or more features associated with the activity type in the data that it collects.

In a variation on this embodiment, the activity descriptions include at least one of: a type of the activity, a state of the activity, an instance of the activity, and a feature of the type, state, or instance of the activity.

In a further variation, the feature of the activity comprises at least one of: a characteristic document, a specific role, a specific resource, a keyword or combination of words associated with the activity, a user action associated with the activity, and a web-query pattern associated with the activity.

In a variation on this embodiment, the system further collects activity descriptions from users with different viewpoints including at least one of: a personal viewpoint, an analyst viewpoint, a group viewpoint, and a general public viewpoint.

In a further variation, the system uses a personal viewpoint to detect an activity instance and uses a group viewpoint to detect an activity type.

In a variation on this embodiment, the user is also allowed to evaluate and rank the features.

In a further variation, a feature is weighted by at least one of: the frequency of the feature being submitted by users, a combined weight from the weights that users themselves have attributed to their votes for the feature, the distinctiveness of the feature associated with the activity, the correlation of the feature with respect to other activity descriptions, the source and viewpoint of the feature, and the reputation and/or degree of knowledge of the user who submits the feature.

In a further variation, the system derives an overall score for detected features associated with an activity by counting and combining the counts of the weighted features that have been detected at a particular time point.

In a further variation, the system detects a dominant user activity by applying a threshold such as mean or median function to a sliding time window and determining whether the overall score of any activity type exceeds the threshold, or by detecting peaks of the overall scores of each activity description over a period of time and using a function of the height and duration of these peaks defined relative to background values to derive the boundaries of each dominant user activity.

### BRIEF DESCRIPTION OF THE FIGURES

FIG. 1 presents a diagram illustrating a system for collecting activity features in accordance with an embodiment of the present invention.

FIG. 2 presents a diagram illustrating a system for detecting human-specified activities in accordance with an embodiment of the present invention.

FIG. 3 presents a flow chart illustrating the process of identifying user activities in accordance with an embodiment of the present invention.

FIG. 4 illustrates an exemplary computer system for detecting human-specified activities in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of identifying human activities based on activity features provided by humans. The system for detecting user activities first collects and aggregates activity type, state, and instance descriptions from people with different viewpoints with regard to what features best describe activities. The people are allowed to add, remove, or vote for the features associated with the activities. Based on the collected activity features, the system then identifies a user activity as a typed, instantiated, and stateful entity by detecting one or more features associated with the activity type, state, and instance.

In this disclosure, the terms “task” and “activity” are loosely interchangeable.

### Activity Models

If a computer could accurately identify and classify a user's activity into its type, state, and instance, the computer could help automatically retrieve files the user needs, fill in the user's timecard, pull up useful tools and web resources related to the user's current activity, provide guidance when the user performs the task in a wrong way, remind the user about his or her time schedule, or propose better time management. The computer could also discover new tasks started by the user and take the chance to learn about the new tasks or issue warnings if the tasks are unauthorized. For example, the computer might include a mechanism for reporting unrecognized features and getting them to be labeled as some activity type by people. In one embodiment, the computer detects occasional high co-occurrence of relatively infrequent word features, such as “wedding,” “marriage,” “bride,” “groom,” “bridesmaid,” “honeymoon,” etc., and filenames such as “guest_list,” “invitation,” and “seating_plan.” The computer could post them as a cluster publicly or privately to the end-user. People or the end-user can then be invited to suggest what activity type this might be and what state it might be in, with the most frequent suggestions “winning” after some absolute or proportional threshold relative to the next most frequent suggestion as the de facto activity definition and thence forth being treated like other activity types.

Building on top of recent advances in computational context sensing, pattern analysis and recognition, and machine learning, work has begun on activity-oriented classification of the data created by human online behavior or sensed offline behavior. Such data is typically analyzed in a bottom-up direction by the analyzer relying only on his or her belief about what data to pay attention to in the human activity or activities or activities of interest. While this analyst-driven approach may yield some useful results, it fails to take into consideration the vast human knowledge about the human meaning of specific data features routinely generated in the course of human activities.

Embodiments of the present invention provide a top-down method of detecting user activities starting from the classification of the activities into meaningful and interesting categories from a human perspective. The term “activity” is sometimes used to refer to something as basic as mere “movement” but it may be used to refer to something as complex and sophisticated as, say, “conference paper writing.” How an activity-detection system defines “activity” can have a major impact on what it means to perform “activity detection” as shown by the following examples in an order of increasing difficulty of analytical abstraction.

Undifferentiated Activity: refers to low-level human movements and actions without identifying the purpose of the activity. This type of activity simply suggests that someone is doing something or using resources. Data collected for undifferentiated activities includes keystrokes, mouse movement, and application usage online, or sensed behaviors or object usage offline. Detecting undifferentiated activity may be useful in aiding human memory for later information retrieval, and providing contextual background information for applications such as supporting team awareness.

Differentiated Activity: focuses on associating temporally proximal and similar or otherwise related (usually textual) content data with distinct activities. The differentiated activity model does not categorize activities into various types; hence, it is restricted to applications that only require associating like with like, such as organizing data and managing personal information.

Simply Typed Activity: refers to activities with simple patterns that can be extracted and typed. Meaningful labels can be applied to these activities manually based on real-world knowledge, such as “walking” versus “sitting” and “AtWork” versus “DiningOut.” This works well for a small set of activities when the scale of the labeling task is limited. Simply typed activity detection can be used to monitor the presence or absence of activities with known types, for example, in leisure recommending systems (shopping versus dining) and fitness monitoring systems (sitting versus jogging).

Richly Typed and Stateful Activity: is the most ambitious and powerful type of activity detection and models activities defined in a human-meaningful way. Previous activity detection of this type has focused on “activities of daily living” (ADLs) such as “making tea” and “housework.” In order to build models of these activities, activities can be performed in an experimental setting using instrumented objects such as cups and kettles to collect sensed data from any instrumented objects as they are used. An interesting technique for mapping the identified used objects to specific ADLs involves going online and searching the web for instructions on how to perform the activities. Instructions to perform an activity usually include the names of the objects needed in the sequence in which they are used. This can help identify not only the activity type, but also the state of the activity as it proceeds. Other methods are also proposed to learn idiosyncratic variations of the ADL based on observing different activity instances, which allow more powerful means to detect activity states, even when individuals tend to perform the same activity differently. The richly typed and stateful activity model makes it possible to implement an activity-aware support system for elders and persons with cognitive impairment by providing timely reminders, useful guidance, or health alert services.

Embodiments of the present invention are optimized for detecting enterprise-level online activities rather than activities of daily living but could equally well be applied to ADLs in place of the web searches for instructions on how to do activities. Enterprise activities do not necessarily involve embodied actions with physical artifacts that can be instrumented with sensors, like daily housework, but typically involve a mix of online and offline events, each of which shares a common motive, may involve communication or interaction with a particular constellation of people, uses particular resources to modify particular work objects and has its own individual temporal sequences and scope. Because such activities are frequently mainly enacted online (with little or no physical artifact use apart from the personal computer and mobile phone), highly variable, heavily collaborative, greatly interleaved and often lasting over periods of days or several weeks with frequent spells of dormancy, most enterprise activities pose many more complexities in detection than typical activities of daily living. Therefore, instead of collecting data from instrumented household objects and mining activity descriptions on the web, embodiments of the present invention employ more expensive social or crowd-based methods to acquire rich activity descriptions and sequences of actions to build richly typed and stateful activity models.

Embodiments of the present invention provide a method and a system primarily intended for identifying richly typed and stateful activities in the enterprise, although it could also be applied to computer-intensive non-enterprise activities such as planning a wedding or making travel arrangements. The applications of the invention include:
providing automatic data on how computers support or fail to support critical activities;
documenting how activities are carried out to pinpoint the shortcuts or inefficiencies in the procedures and workflows, which employees are performing that may be most optimal or that cause delays;
capturing useful state information and accessing necessary resources to provide timely reminders and smart support for the steps that are required at a given stage in an activity;
determining irregularities or failures in the activities suggesting need for technical support and training; and
detecting unusual and suspicious activities indicating emergencies or security threats.

### Activity Features and Detection

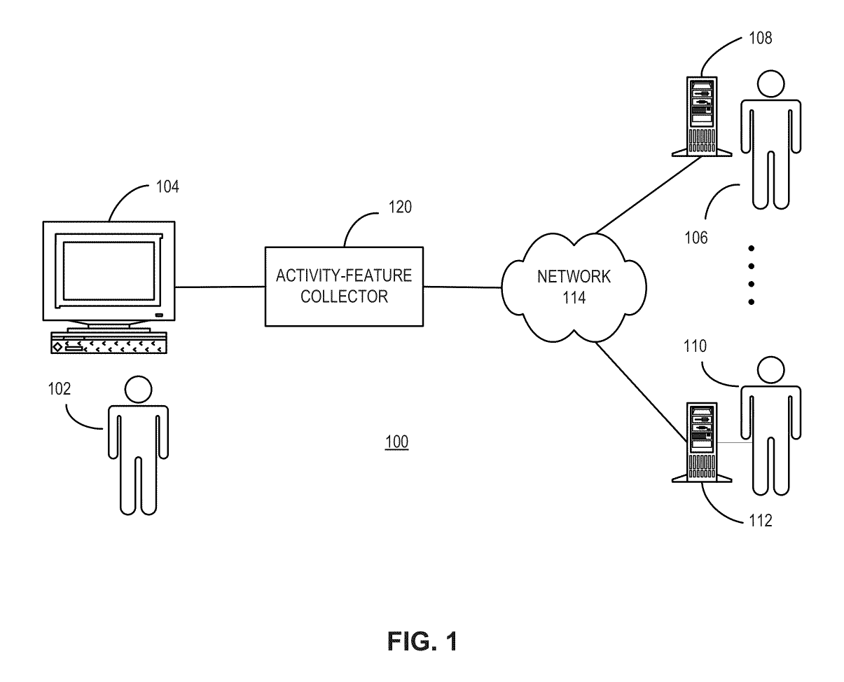

Embodiments of the present invention provide a system for identifying user activities as belonging to typed, instantiated and stateful activities, rather than simple collections of related content. Enterprise-level activities may include hiring a new employee, writing a technical paper, organizing a workshop and so on. Since these activities are quite complicated, they may be decomposed into multiple sub-activities. For example, hiring a new employee may involve sub-activities such as organizing a committee, distributing interview schedules, and collecting feedback. In order to identify these activities, the system first collects and aggregates activity descriptions including sub-tasks and stages or states and their features from a plurality of users to build a stateful activity model. This basic idea of using human-specified features to identify an activity can be applied in different computing environments. One such example is illustrated by the feature-collecting system 100 shown in FIG. 1, which facilitates collecting user-specified activity features from a plurality of users in accordance with an embodiment.

In this example, a user 102 performs his task on a computer 104; similarly, users 106 and 110 perform their tasks on servers 108 and 112 respectively. While performing their tasks, users 102, 106, and 110 may access a number of documents and/or applications located on computer 104 or on servers 108 and 112, which are coupled to network 114. An activity-feature collector 120 monitors the users' usage of documents and/or accesses of resources, and aggregates document-usage and/or resource-access information including timestamps, states of the task processes, and document and resource particulars for each user activity. Activity-feature collector 120 also allows users 102, 106, and 110, through a dedicated application running on computer 104 and servers 108 and 112, to label the activity types of their tasks and to add, remove, evaluate, rank, or vote for any user-specified features associated with an activity from their own viewpoints. The vote of any user may itself be weighted such that the user can give a low weight to his or her vote or a high one. Based on these collected, aggregated activity descriptions, which can be made publicly or intra-organizationally available or kept private to one user, the system can build activity models and perform activity detections. This may be accomplished via various combinations of distributed or centralized processing (for example, detecting features on a personal machine and reporting feature counts to a feature collector, 120, or performing all processing and activity detection entirely on a personal machine, 102). Note that although FIG. 1 shows only three users, more users can be accommodated in the system.

In one embodiment, activity descriptions associated with an activity include, but are not limited to: a type of the activity; a state of the activity; an instance of the activity, and a feature of the activity, state or instance. An activity, an activity state, or an activity instance can be uniquely defined and identified by a combination of the various kinds of features associated with the activity, state, or instance, which comprises at least one of: characteristic documents, specific resources (devices, applications, portals, etc.), people that play specific roles, semantic entities (companies, places, events, etc.), a pattern of web queries, and keywords associated with the activity, activity state or instance.

The descriptions and features of the activities are collected from users with different viewpoints via at least one of a single-user description, a crowd-sourcing system, structured interviews, and ethnographic observations. The descriptions may have restricted use for activity detection, perhaps being personal and private to an individual or private to an organization or publicly available for use in activity detection. Various viewpoints may also be defined to classify features and determine how to apply those features, for example privately only, or publicly, or with greater or lesser weighting. Viewpoints may include: a personal viewpoint, a group viewpoint, a general public viewpoint, and an analyst viewpoint. Activity features from a personal viewpoint or the viewpoint of individuals collaborating on a specific activity are necessary to define an instance of the activity (e.g., a specific person's name). Individuals within a specific organization may be the only ones that can identify features of certain specific states of certain activities (e.g., a specific unmodified form implying the beginning of a certain activity). While the general public may contribute generally understood features of the activities and their states (e.g., room reservations and attendee invitations when organizing a meeting), an analyst or an expert in the activity domain, on the other hand, may provide a much richer set of certain types of activity features than the general public.

Whenever the activity-detection system is running a live interaction with the feature collector, each spotted feature represents a stimulus or a score for the associated activity at a given time point. The score of the feature is weighted according to at least one of: the frequency of the feature being submitted by users, the combined weights users themselves attributed to their votes for the feature, the distinctiveness of the feature associated with the activity, the historical correlation of the feature with respect to the activity of interest versus its historical correlation with other activities, the source and viewpoint of the feature, and the reputation and knowledgeability of the user who submits the feature. The distinctiveness of the feature can be derived using measures such as TF-IDF. For example, the keyword ‘meeting’ is commonly used, thus is less distinctive than the keyword ‘candidate.’ The correlation represents how tightly a feature when detected clusters with other detected features included in the activity descriptions. Furthermore, features provided by an analyst with more expertise weigh more than those provided by a member of the general public. Similarly, a reputable user may weigh more than other sources based on his or her social connections or citations.

Activity features may appear in some specific temporal relationship to one another in an ongoing activity stream at the micro level, or in an extended workflow at the macro level. The weighted score of a spotted feature at any given time decays over time, i.e., over a certain time period, the feature's score decrements by discrete units to zero. An overall score of the activity description can be derived by combining the weighted scores of all features with non-zero values at a particular time point, accounting for all feature detection in the recent past. A stimulus curve consisting of all the scores within a time range for each activity can thus be formed to detect the activity. Activity detection takes this curve and applies either an online or an offline algorithm. Online detection utilizes the average mean/median of a sliding time window as a single detection threshold for all the feature scores combined, or a combination of multiple detection thresholds for each kind of feature for detection; an offline algorithm, on the other hand, applies a successive robust mean estimation to the stimulus curve to isolate the peaks and hereby the boundaries of the activity.

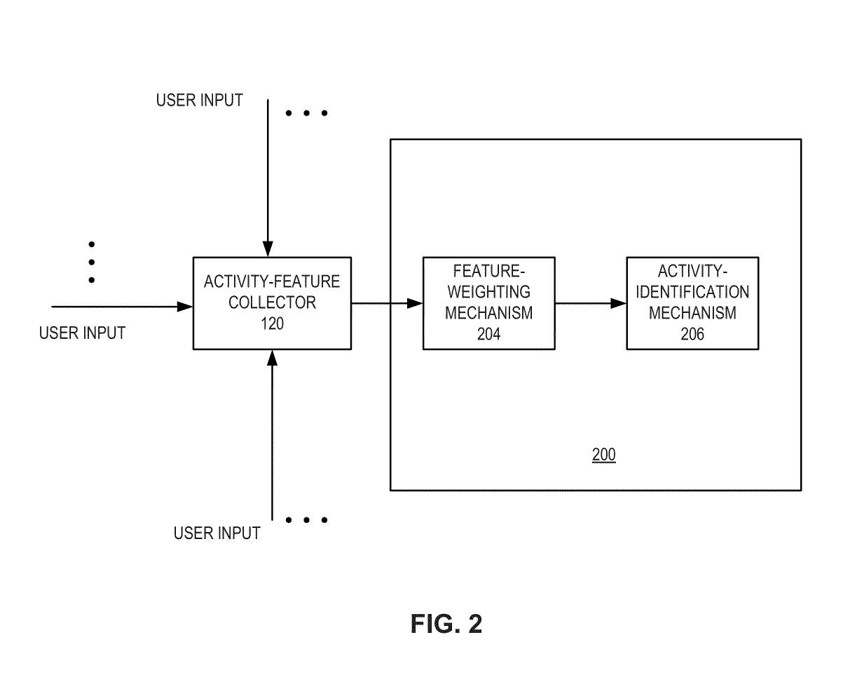

FIG. 2 presents a diagram illustrating a system for detecting human-specified activities in accordance with an embodiment of the present invention. System 200 includes a feature-weighting mechanism 204 and an activity-identification mechanism 206. During operation, activity-feature collector 120 collects and aggregates activity descriptions from a plurality of users, wherein a respective user is allowed to add, remove, or vote for at least one feature associated with the activity from a predetermined viewpoint. Examining the output on an ongoing basis for each user from activity-feature collector 120, feature-weighting mechanism 204 then generates a moment-by-moment score for a given activity type, which rises and falls over time in a stimulus curve of weighted scores for all the features collected for each activity. Based on the stimulus curve, activity-identification mechanism 206 detects user activities of interest. Note that although FIG. 2 illustrates only three sets of user input, a larger number of user inputs can be accommodated by the system.

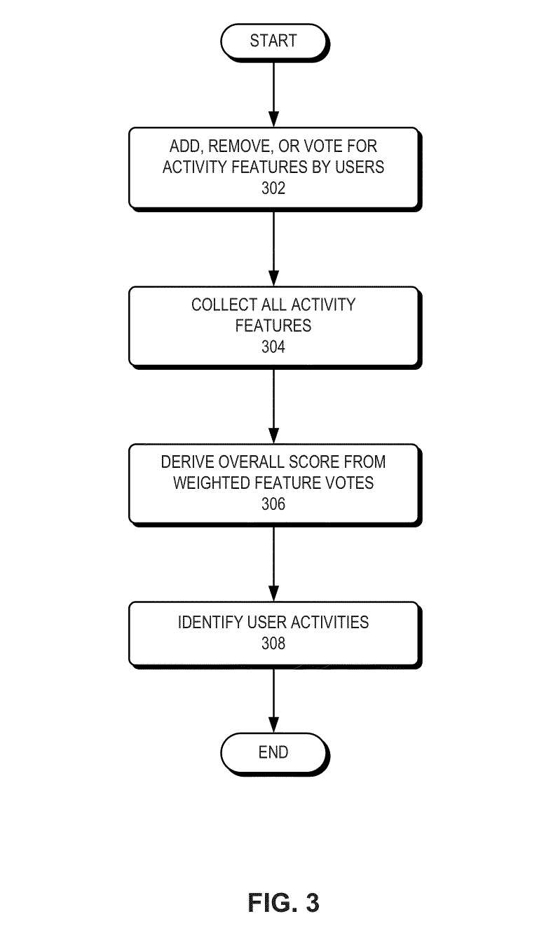

FIG. 3 presents a flow chart illustrating the process of identifying user activities in accordance with an embodiment of the present invention.

During operation, the system allows users to add, remove, or vote for activity features (operation 302), and collects all the activity features (operation 304). The system then derives an overall score from weighted feature votes (operation 306), and identifies user activities (operation 308).

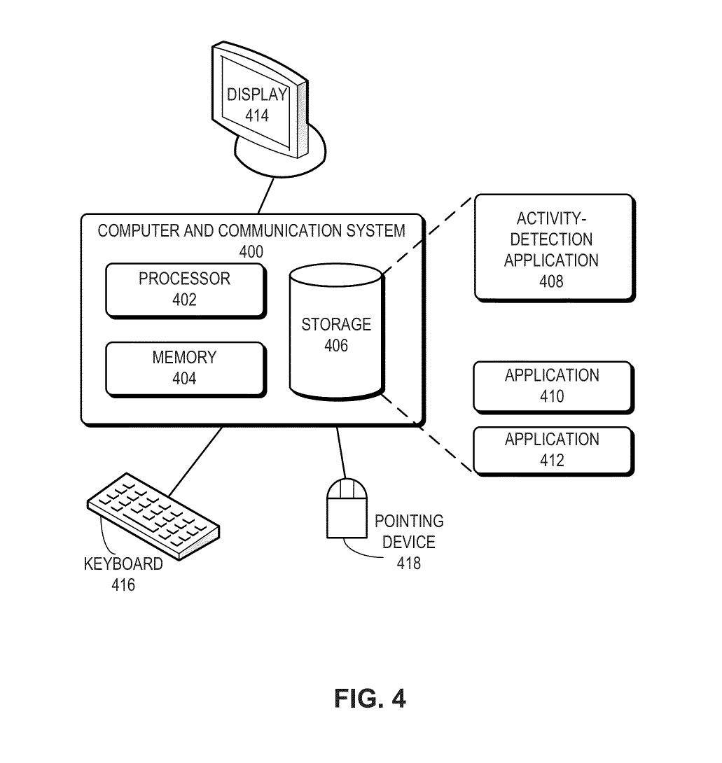

FIG. 4 illustrates an exemplary computer system for detecting user tasks in accordance with one embodiment of the present invention. In one embodiment, a computer and communication system 400 includes a processor 402, a memory 404, and a storage device 406. Storage device 406 stores an activity-detection application 408, as well as other applications, such as applications 410 and 412. During operation, activity-detection application 408 is loaded from storage device 406 into memory 404 and then executed by processor 402. While executing the program, processor 402 performs the aforementioned functions. Computer and communication system 400 is coupled to an optional display 414, keyboard 416, and pointing device 418.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for identifying user activities, the method comprising:
collecting activity descriptions from a plurality of users, wherein a respective user is allowed to add, remove, or vote for at least one feature associated with the activity from a predetermined viewpoint; and
identifying a user activity as a typed, stateful, and instantiated entity by detecting one or more features associated with at least one of: a type, state, and instance, of the entity.

2. The method of claim 1, wherein the activity descriptions include at least one of:
a type of the activity;
a state of the activity;
an instance of the activity; and
a feature of the activity.

3. The method of claim 2, wherein the feature of the activity type, instance, and/or state comprises at least one of:
a characteristic document;
a specific role;
a specific resource;
a keyword associated with the activity;
a user action associated with the activity; and
a web-query pattern associated with the activity.

4. The method of claim 1, further comprising collecting activity descriptions from users with different viewpoints, which include at least one of:
a personal viewpoint;
an analyst viewpoint;
a group viewpoint; and
a general public viewpoint.

5. The method of claim 4, further comprising:
using a personal viewpoint to detect an activity instance; and
using a group viewpoint to detect an activity type.

6. The method of claim 1, wherein the user is also allowed to evaluate and rank the features.

7. The method of claim 6, wherein the feature is weighted by at least one of:
a frequency of the feature being submitted by users;
a combined weight from the weights that users themselves have attributed to their votes for the feature;
a distinctiveness of the feature associated with the activity;
a correlation of the feature with respect to other descriptions;
a source and viewpoint of the feature; and
a reputation of the user who submits the feature.

8. The method of claim 7, further comprising deriving an overall score of the activity description by combining the scores of the weighted features at a particular time point.

9. The method of claim 8, further comprising detecting a dominant user activity by applying a mean or median function to a sliding time window and determining the highest overall score of all activity description, or by detecting the peaks of the overall scores of each activity description over a period of time and using these peaks to derive the boundaries of each dominant user activity.

10. A non-transitory computer-readable storage medium storing instructions that when executed by a computer cause the computer to perform a method for identifying user activities, the method comprising:
collecting activity descriptions from a plurality of users, wherein a respective user is allowed to add, remove, or vote for at least one feature associated with the activity from a predetermined viewpoint; and
identifying a user activity as a typed, stateful, and instantiated entity by detecting one or more features associated with at least one of: a type, state, and instance, of the entity.

11. The non-transitory computer-readable storage medium of claim 10, wherein the activity descriptions include at least one of:
a type of the activity;
a state of the activity;
an instance of the activity; and
a feature of the activity.

12. The non-transitory computer-readable storage medium of claim 11, wherein the feature of the activity type, instance, and/or state comprises at least one of:
a characteristic document;
a specific role;
a specific resource;
a keyword associated with the activity;
a user action associated with the activity; and
a web-query pattern associated with the activity.

13. The non-transitory computer-readable storage medium of claim 10, wherein the method further comprises collecting activity descriptions from users with different viewpoints, which include at least one of:
a personal viewpoint;
an analyst viewpoint;
a group viewpoint; and
a general public viewpoint.

14. The non-transitory computer-readable storage medium of claim 10, wherein the user is also allowed to evaluate and rank the activity descriptions.

15. The non-transitory computer-readable storage medium of claim 14, wherein a feature is weighted by at least one of:
a frequency of the feature being submitted by users;
a combined weight from the weights that users themselves have attributed to their votes for the feature;
a distinctiveness of the feature associated with the activity;
a correlation of the feature with respect to other descriptions;
a source and viewpoint of the feature; and
a reputation of the user who submits the feature.

16. The non-transitory computer-readable storage medium of claim 15, wherein the method further comprises deriving an overall score of each activity description by combining the scores of the weighted features at a particular time point.

17. The non-transitory computer-readable storage medium of claim 16, wherein the method further comprises detecting a dominant user activity by applying a mean or median function to a sliding time window and determining the highest overall score of all activity description, or by detecting the peaks of the overall scores of each activity description over a period of time and using these peaks to derive the boundaries of each dominant user activity.

18. A system for identifying user activities, the system comprising:
a collecting mechanism configured to collect activity descriptions from a plurality of users, wherein a respective user is allowed to add, remove, or vote for at least one feature associated with the activity from a predetermined viewpoint; and
an identification mechanism configured to identify a user activity as a typed, stateful, and instantiated entity by detecting one or more features associated at least one of: a type, state, and instance, of with the entity.

19. The system of claim 18, wherein the activity descriptions include at least one of:
a type of the activity;
a state of the activity;
an instance of the activity; and
a feature of the activity.

20. The system of claim 19, wherein the feature of the activity type, instance, and/or state comprises at least one of:
a characteristic document;
a specific role;
a specific resource;
a keyword associated with the activity;
a user action associated with the activity; and
for a web-query pattern associated with the activity.

21. The system of claim 18, wherein the collecting mechanism is further configured to collect activity descriptions from users with different viewpoints, which include at least one of:
a personal viewpoint;
an analyst viewpoint;
a group viewpoint; and
a general public viewpoint.

22. The system of claim 18, wherein the user is also allowed to evaluate and rank the activity descriptions.

23. The system of claim 22, wherein a feature is weighted by at least one of:
a frequency of the feature being submitted by users;
a combined weight from the weights that users themselves have attributed to their votes for the feature;
a distinctiveness of the feature associated with the activity;
a correlation of the feature with respect to other descriptions;
a source and viewpoint of the feature; and
a reputation of the user who submits the feature.

24. The system of claim 23, further comprising a scoring mechanism configured to derive an overall score of each activity description by combining the scores of the weighted features at a particular time point.

25. The system of claim 24, wherein the identification mechanism is configured to detect a dominant user activity by applying a mean or median function to a sliding time window and determining the highest overall score of all activity description, or by detecting the peaks of the overall scores of each activity description over a period of time and using these peaks to derive the boundaries of each dominant user activity.
